(19) United States
(12) Patent Application Publication
(10) Pub. No.: US 2020/0006883 A1
(43) Pub. Date: Jan. 2, 2020

(54) Electrical Receptacle with Self Engaging Power Shut-Off Protection

(71) Applicant: Omron Automotive Electronics Co., Ltd., Aichi (JP)

(72) Inventors: Gabriel Tirlea, Long Grove, IL (US); Guy Wojtanek, West Chicago, IL (US); Ryan Spear, Batavia, IL (US)

(21) Appl. No.: 16/020,136

(22) Filed: Jun. 27, 2018

(51) Int. Cl. H01R 13/447; H02H 7/122; H01R 13/506; H01R 13/68; H01R 13/713; H01R 13/66

(52) U.S. Cl. CPC H01R 13/447; H02H 7/1225; H01R 13/6675; H01R 13/68; H01R 13/713; H01R 13/506

(57) ABSTRACT

Embodiments of the present disclosure include an electrical receptacle, comprising a base formed of electrically insulating material and arranged to hold at least one pair of electrically conductive terminals, and a cover formed of electrically insulating material and configured to be joinable with the base. The cover can comprise a top portion having a bottom surface, and at least one separating tab attached to the bottom surface at an angle of ˜90 degrees. Each separating tab can be arranged to separate opposite terminals, of a terminal pair, only when the cover is at least partially joined with the base. Base and cover can include, respectively, locking tabs and receptacles configured to engage when base and cover are fully joined. Embodiments also include power supply circuits comprising a DC-AC inverter, a load protection circuit, and embodiments of the electrical receptacle. Embodiments also include methods for protecting a power supply circuit.

### TECHNICAL FIELD

The present invention generally relates to safety protection of electrical power supply circuits, and more specifically to an electrical receptacle with a safety mechanism that can be used as part of an intelligent power supply circuit.

### BACKGROUND

With advances in communications technology, the world is moving toward a connected society. Improvements in wireless network speed, coverage, and accessibility, as well as the pervasiveness of online connections, enable individuals to have ubiquitous access to information and services—anytime and anywhere. This mobile-centric approach has brought—and will continue to bring—significant changes in education, health care, transportation, energy, and entertainment.

Individuals can now use a variety of devices for ubiquitous access to these services, including smartphones, tablets, laptop computers, smart glasses, etc. Although these devices differ in form and function, all share the common feature of having a rechargeable battery as an energy source. As such, the ability to maintain ubiquitous access to online services is greatly dependent on the ability to recharge batteries of these electronic devices.

Furthermore, due to the increases in energy storage capacity/density of rechargeable batteries, various devices that traditionally included an AC power cord are now becoming battery-powers. For example, as lithium ion batteries have become more prevalent, many power tools used by professionals and/or tradespersons have become battery-powered. Much like the access devices discussed above, the value of these tools is greatly dependent on the ability to recharge the batteries whenever necessary.

Accordingly, vehicle manufactures today are providing DC-AC inverters and AC outlet sockets in vehicles as convenience features to facilitate vehicle-based operation and/or battery-charging for these electronic devices and/or tools. The AC outlet socket is the interface with the plug on the electronic device, which is also referred to herein as an “electrical receptacle.” This socket typically supplies AC electricity at voltages of 110V to 230V. A voltage of this value has the potential to cause hazard—including death—by electrocution to an individual exposed to it. To protect against this potential hazard, the electrically-conductive outlet terminals are usually contained within a non-conductive enclosure, thereby making it difficult for the user to come in contact with the conductive terminals.

However, the degree of difficulty depends on the design of the non-conductive enclosure. Often, this enclosure must be designed in multiple pieces and/or parts in order to facilitate assembly with the conductive terminals. In such case, it can be possible—even with some difficulty—for the user to remove an outer part of the enclosure such that the conductive terminals are exposed when the electrical socket is energized. As such, this leaves the user exposed to the hazard that the enclosure was intended to prevent.

### SUMMARY

Accordingly, to address at least some of such issues and/or problems, certain exemplary embodiments of methods, electrical receptacles, and/or power supply circuits according to the present disclosure can prevent the potential electrocution hazard discussed above, thereby facilitating safe use of AC electricity in vehicles. These improvements can facilitate adoption of AC electrical outlets in vehicles in a manner that is acceptable, desirable, and/or preferred by end users, manufacturers, and regulatory agencies.

Exemplary embodiments of the present disclosure include various embodiments of an electrical receptacle. In various embodiments, the electrical receptacle can include a base formed of electrically insulating material and arranged to hold at least one pair of electrically conductive terminals. In various embodiments, the electrical receptacle can also include a cover formed of electrically insulating material and configured to be joinable with the base. The cover can comprise a top portion having a bottom surface, and at least one separating tab attached to the bottom surface at an angle of approximately 90 degrees. Each separating tab can be arranged to separate two terminals comprising one of the pairs of electrically conductive terminals, only when the cover is at least partially joined with the base. In such embodiments, each separating tab can be arranged such that it does not separate two terminals when the cover is separated from the base.

In other embodiments, each separating tab can be arranged to separate the two terminals comprising one of the pairs of electrically conductive terminals only when the cover is fully joined with the base. In such embodiments, each separating tab can be arranged such that it does not separate two terminals when the cover is either partially joined with or separated from the base.

In some embodiments, the base can further comprise an inner portion arranged to hold the at least one pair of electrically conductive terminals, and an outer portion comprising four sides, wherein at least two of the sides comprise locking tabs. In some embodiments, each adjacent pair of sides of the base outer portion are joined at an angle of approximately 90 degrees.

In some embodiments, the cover can further comprise a side portion attached to the bottom surface of the top portion at an angle of approximately 90 degrees. The cover side portion can include four sides, at least two of which can comprise locking receptacles. The locking receptacles can be arranged to engage with the locking tabs when the cover and the base are fully joined. In some embodiments, the locking receptacles can be arranged to not engage with the locking tabs when the cover and the base are partially joined or separated.

In some embodiments, each adjacent pair of sides of the cover side portion are joined at an angle of approximately 90 degrees. In some embodiments, the cover top portion can comprise at least two apertures arranged such that, when the base and the cover are at least partially joined, each aperture is disposed above a corresponding one of the electrically conductive terminals. In some embodiments, the electrical receptacle can also include a source terminal coupled to a first terminal of each pair of electrically conductive terminals, and a fuse disposed between the source terminal and the respective first terminals.

Exemplary embodiments of the present disclosure also include various embodiments of a power supply circuit. In various embodiments, the power supply circuit can include a DC-AC inverter comprising an AC generation circuit. The power supply circuit can also include an electrical receptacle comprising a base and a cover, both of which can be formed of electrically insulating material. The cover can be configured to be joinable with the base, and vice versa. The base can be arranged to hold at least one pair of electrically conductive terminals that are electrically coupled to the DC-AC inverter.

The cover can comprise a top portion having a bottom surface and at least one separating tab attached to the bottom surface at an angle of approximately 90 degrees. In some embodiments, each separating tab can be arranged to separate two terminals comprising a particular pair of electrically conductive terminals, only when the cover is at least partially joined with the base. In other embodiments, each separating tab can be arranged to separate two terminals comprising a particular pair of electrically conductive terminals, only when the cover is fully joined with the base.

The power supply circuit can also include a protection circuit configured to prevent the DC-AC inverter from energizing the electrical receptacle when the power supply circuit is in an overload condition resulting from contact between two terminals comprising one of the pairs of electrically conductive terminals. In some embodiments, the protection circuit can be further configured to enable the DC-AC inverter to energize the electrical receptacle when the power supply circuit is in a normal operating condition. In some embodiments, the protection circuit can be further configured to prevent the DC-AC inverter from energizing the electrical receptacle when the power supply circuit is in a no-load condition.

In some embodiments, the protection circuit can be a fuse, which can be integral with the electrical receptacle. In some embodiments, the electrical receptacle can also include a source terminal coupled to an output of the AC generation circuit, and the fuse can be disposed between the source terminal and a first terminal of each pair of electrically conductive terminals.

In some embodiments, the protection circuit can be integral with the DC-AC inverter. In such embodiments, the protection circuit can comprise a load detection circuit configured to measure one or more parameters associated with the DC-AC inverter's AC output to the electrical receptacle. In such embodiments, the protection circuit can further comprise a processing circuit configured to compare the measured one or more parameters with corresponding first thresholds associated with the overload condition. The processing circuit can also be configured to, if the comparison with the first thresholds indicates an overload condition, perform at least one of the following: decouple the DC-AC inverter from a DC supply input, and disable the AC generation circuit. In some embodiments, the processing circuit can be further configured to generate a diagnostic trouble code (DTC) if the comparison with the first thresholds indicates an overload condition.

In some embodiments, the processing circuit can be further configured to compare the measured one or more parameters with corresponding second thresholds associated with the no-load condition. In such embodiments, the processing circuit can be further configured to, if the comparison with the second thresholds indicates a no-load condition, perform at least one of the following: decouple the DC-AC inverter from the DC supply input, and disable the AC generation circuit.

Various exemplary embodiments of the power supply circuit can comprise one or more electrical receptacles corresponding to any of the exemplary electrical receptacle embodiments described herein.

Exemplary embodiments of the present disclosure also include various methods and/or procedures for protecting a power supply circuit, comprising an electrical receptacle, against an overload condition. In various embodiments, the exemplary methods and/or procedures can include detecting an overload condition of the power supply circuit, the overload condition resulting from separation of a cover portion of the electrical receptacle from a base portion of the electrical receptacle. The exemplary methods and/or procedures can also include, in response to detecting the overload condition, performing at least one of the following: decoupling the power supply circuit from an energy source, and disabling an output of the power supply circuit that is coupled to the electrical receptacle.

In some embodiments, the exemplary methods and/or procedures can also include detecting a normal operating condition of the power supply circuit, the normal operating condition resulting from the cover portion and the base portion being at least partially joined. In such embodiments, the exemplary methods and/or procedures can also include, in response to detecting the overload condition, performing at least one of the following: coupling the power supply circuit to the energy source, and enabling the output of the power supply circuit.

These and other aspects, features, and advantages will become apparent upon reading the following detailed description of the exemplary embodiments of the present disclosure, when taken in conjunction with the appended claims.

### BRIEF DESCRIPTION OF THE DRAWINGS

FIG. 1 is an isometric top view of an electrical receptacle cover, according to exemplary embodiments of the present disclosure.

FIG. 2 is a cross-sectional view of the electrical receptacle cover, according to exemplary embodiments of the present disclosure.

FIG. 3 is an isometric top view of an electrical receptacle base, according to exemplary embodiments of the present disclosure.

FIG. 4 is an isometric top view showing the electrical receptacle cover and base fully joined, according to exemplary embodiments of the present disclosure.

FIG. 5 is an isometric top view showing the electrical receptacle cover and base partially joined, according to exemplary embodiments of the present disclosure.

FIG. 6 is an isometric top view showing the electrical receptacle cover and base separated, according to exemplary embodiments of the present disclosure.

FIGS. 7-9 are block diagrams of various power supply circuits comprising any of the electrical receptacles shown in FIGS. 1-6, according to exemplary embodiments of the present disclosure.

FIG. 10 is a flow diagram of an exemplary method and/or procedure for protecting a power supply circuit, comprising an electrical receptacle, against an overload condition, according to exemplary embodiments of the present disclosure.

### DETAILED DESCRIPTION

Exemplary embodiments of the present disclosure can reduce, mitigate, and/or prevent the potential electrocution hazard discussed above, thereby facilitating safe use of AC electricity in vehicles. These improvements can facilitate adoption of AC electrical outlets in vehicles in a manner that is acceptable, desirable, and/or preferred by end users, manufacturers, and regulatory agencies. Existing and/or conventional approaches to electrical outlet safety typically rely on leaving the outlet (or receptacle) energized but blocking access to the openings (or apertures) for insertion of the plug terminals. These conventional approaches do not address the case where the receptacle cover (or faceplate) is removed, thereby exposing the user to a dangerous condition.

In contrast, embodiments of the present disclosure address this situation by causing the opposite terminals of the electrical receptacle to be electrically shorted when the receptacle is not fully assembled (e.g., a cover is removed from a base). The short condition can be removed—and the receptacle can become operational again—by reassembly (e.g., reattachment of the cover to the base), which reintroduces electrical isolation between the opposite terminals of the receptacle. Embodiments of the present disclosure can also include mechanisms for maintaining the receptacle in a fully-assembled condition, thereby making disassembly more difficult.

Embodiments of the present disclosure also provide advantages and benefits when such electrical receptacles are used in a power supply circuit that also includes a DC-AC inverter and a protection circuit. When the receptacle is disassembled causing the short between the opposite terminals, the protection circuit can detect a resulting overload condition and prevent the DC-AC inverter from energizing the receptacle with AC electricity. In embodiments where the protection circuit comprises a fuse, the fuse can also protect the DC-AC inverter from the overload condition, albeit at the expense of the fuse becoming permanently inoperable (i.e., until replaced). As such, the use of the novel electrical receptacles, disclosed herein, in such power supply circuits provides substantial safety benefits to various parties including end users, manufacturers of vehicle power supplies, and vehicle manufacturers.

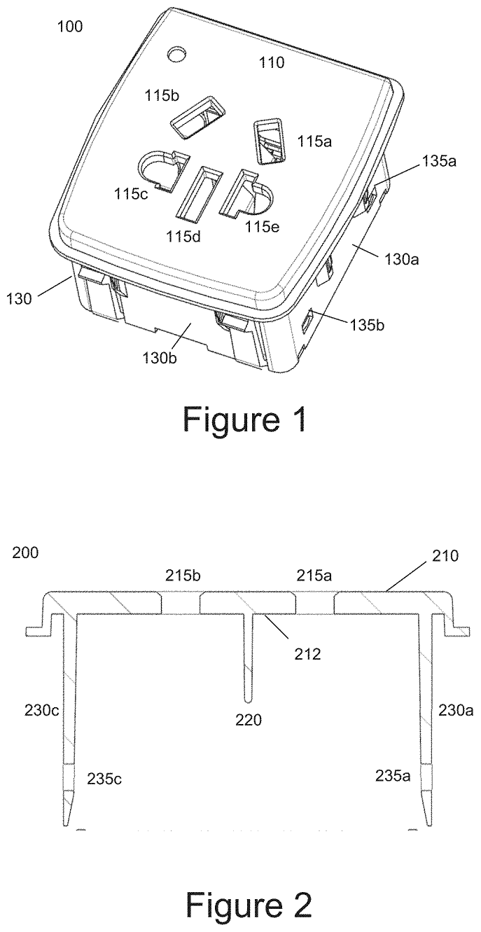

FIG. 1 is an isometric top view of an electrical receptacle cover 100, according to exemplary embodiments of the present disclosure. Cover 100 can be formed of electrically insulating material and configured to be joinable with a base portion, such as described in relation to other figures herein. Cover 100 comprises a top portion 110 and a side portion 130, which is represented in the isometric view of FIG. 1 as adjacent sides 130a-b, which can be joined at an angle of approximately 90 degrees.

As shown in FIG. 1, side 130a includes two locking receptacles 135a-b. Each locking receptacle 135a-b can be an aperture (e.g., hole) through side 130a. The shape of each aperture 135a-b can be configured for compatibility with a corresponding locking tab on a base portion, as explained in more detail below. Although side 130b is shown as having no locking receptacles, this is merely exemplary. In other words, side 130b can have one or more locking receptacles, which can be arranged and/or configured in the same, or in a different, manner as receptacles 135a-b on side 130a, provided that compatibility with corresponding locking tabs on a base portion is maintained.

Top portion 110 also includes a plurality of apertures (e.g., holes), such as apertures 115a-e. The number, shapes, and layout of apertures 115a-e can be arranged for compatibility with terminals on various types of electrical plugs used in various countries and/or regions. In other words, different ones of apertures 115a-e can receive terminals from the various types of electrical plugs with which the cover 100 can be compatible.

FIG. 2 is a cross-sectional view of an electrical receptacle cover 200, according to exemplary embodiments of the present disclosure. In various embodiments, electrical receptacle cover 200 can be substantially similar to cover 100 shown in, and described above in relation to, FIG. 1. Cover 200 can be formed of electrically insulating material and configured to be joinable with a base portion, such as described in relation to other figures herein.

Cover 200 comprises a top portion 210 and a side portion 230, which is represented in the cross-sectional view of FIG. 2 as opposite sides 230a and 230c. As shown in this view, each of opposite sides 230a, 230c includes a locking receptacle, labeled 235a, 235c respectively. As illustrated in FIG. 1, however, each side 230a, 230c can also include a plurality of locking receptacles. As explained in more detail below, each locking receptacle (e.g., 235a, 235c) can be configured to mate with a corresponding locking tab on a base portion, when cover 200 is at least partially joined with the base portion.

As shown in FIG. 2, cover side portion 230 can be attached to bottom surface 212 of cover top portion 210 at an angle of approximately 90 degrees. Separating tab 220 is also attached to the bottom surface 212, e.g., at an angle of approximately 90 degrees. Separating tab 220 can be formed of the same electrically insulating material as the rest of cover 200. As explained in more detail below, separating tab 220 can be configured and/or arranged to separate two conductive terminals contained within a base portion, when cover 200 is at least partially joined with the base portion.

As shown in FIG. 2, top portion 210 also includes two apertures (e.g., holes) 215a and 215b arranged and/or configured to receive two terminals of an electrical plug. The two apertures 215a-b can be part of a plurality of apertures in top portion 210 that are arranged to receive terminals from plugs used in various countries and/or regions, such as apertures 115a-e shown in FIG. 1.

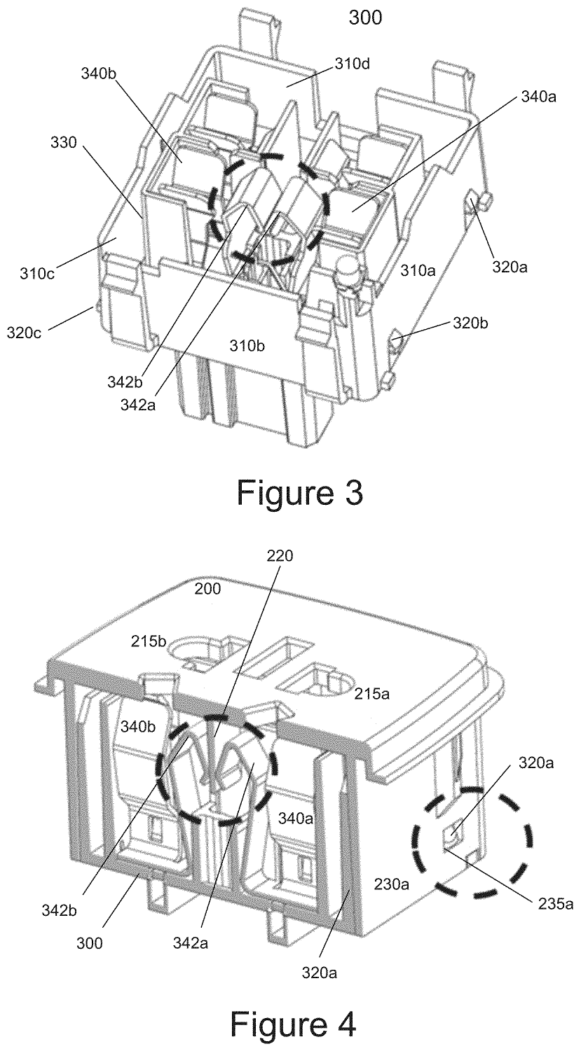

FIG. 3 is an isometric top view of an electrical receptacle base 300, according to exemplary embodiments of the present disclosure. Base 300 can be formed of an electrically insulating (e.g., non-conductive) material and includes an outer portion 310 that comprises four sides, labelled 310a-d. As shown in FIG. 3, each adjacent pair of sides 310a-d (e.g., sides 310a and 310b) can be joined at an angle of approximately 90 degrees, such that outer portion 310 is substantially rectangular in shape.

At least two of the sides 310a-d comprise locking tabs. In the exemplary embodiment shown in FIG. 3, side 310a comprises locking tabs 320a and 320b, while opposite side 310c comprises locking tabs 320c and 320d (not shown). Although each of sides 310a and 310c is shown as having two locking tabs, both the number of sides having locking tabs and the number of locking tabs per side are exemplary. For example, sides 310b and 310d also can have tabs, and each of sides 310a-d can have a single tab or more than two tabs. As a further example, some of sides 310a-d can have a different number of tabs than others of sides 310a-d.

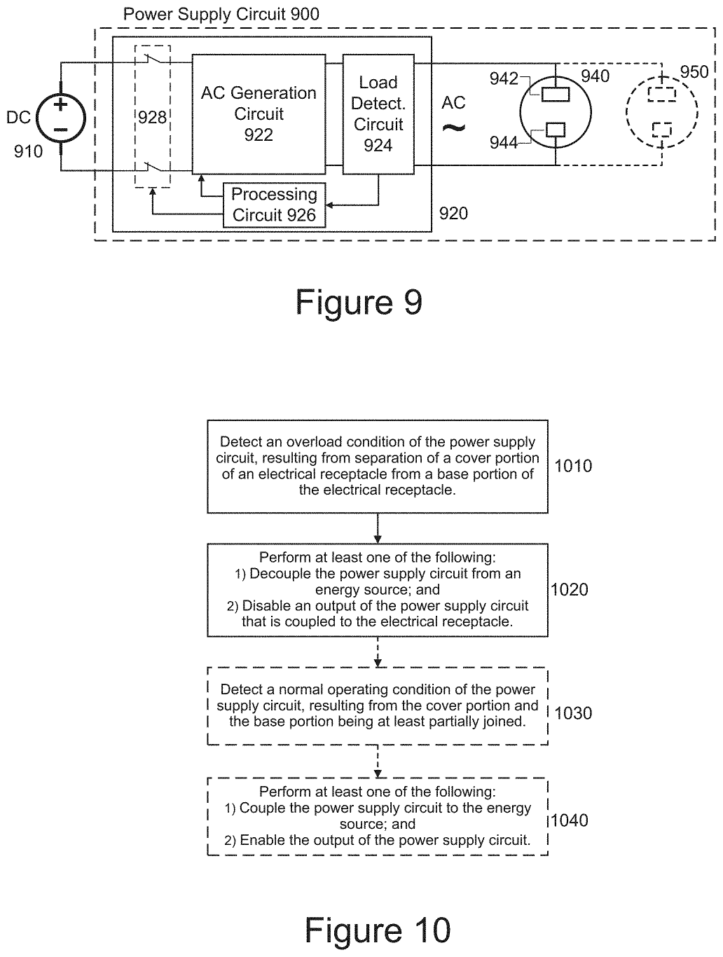

Base 300 also includes an inner portion 330, which is arranged to hold the at least one pair of electrically conductive terminals. For example, inner portion 330 shown in FIG. 9 is arranged to hold one pair of terminals, labelled 340a-b. Each of terminals 340a-b can be formed of various electrically conductive materials known to persons of ordinary skill. Inner portion 330 can be configured to hold terminals 340a-b in a position such that, when a multi-terminal plug is inserted into the electrical receptacle comprising base 300, each of terminals 340a-b comes in contact with a particular terminal of the plug.

Terminals 340a-b can be formed in various shapes to support one or more different types of plug terminal arrangements used in various countries and/or regions. Moreover, receptacle terminals 340a-b can be formed in various shapes that can exert retention force and/or pressure on the inserted plug terminals. Terminals 340a-b also include protrusions 342a-b, respectively. As shown in the dashed circle of FIG. 9, terminals 340-b can be disposed in inner portion 330 such that protrusions 342a-b are in direct electrical contact with each other. Moreover, protrusions 342a-b can be formed in various shapes that can exert force and/or pressure against each other when terminals 340a-b are inserted into inner portion 330 in this manner.

FIG. 4 is an isometric, cut-away top view showing an electrical receptacle with cover 200 and base 300 fully joined, according to exemplary embodiments of the present disclosure. As shown in FIG. 4, when cover 200 and base 300 are fully joined, an outer surface of base side 320a and an inner surface of cover side 230a are substantially adjacent. Base sides 320b-d and cover sides 230b-d are arranged in substantially similar relative orientations. As also shown in FIG. 4, when cover 200 and base 300 are fully joined, locking tab 320a is configured to engage with locking receptacle 235a. Although not shown in this cut-away view, locking tabs 320b-d are configured to engage with respective locking receptacles 235b-d when cover 200 and base 300 are fully joined.

Furthermore, as shown in FIG. 4, when cover 200 and base 300 are fully joined, separating tab 220 of cover 200 is disposed between protrusions 342a-b, such that terminals 340a-b are separated from each other. Since separating tab 220 is formed of an electrically insulating material (e.g., the same material as the rest of cover 200), terminals 340a-b can be electrically isolated from each other by tab 220 when cover 200 and base 300 are fully joined, e.g., with locking tabs 320a-d engaged with respective locking receptacles 235a-d.

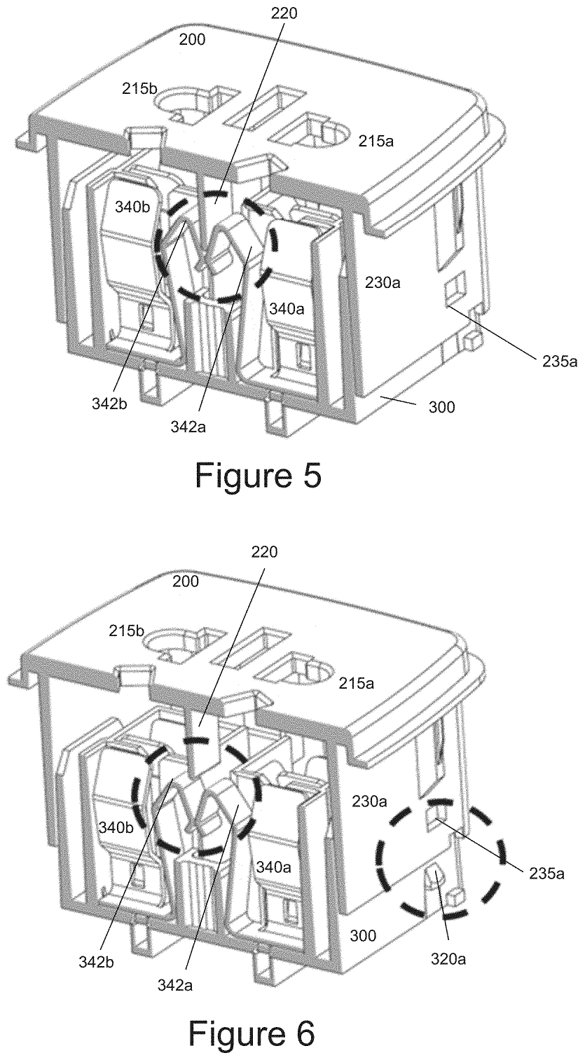

FIG. 5 is an isometric, cut-away top view showing an electrical receptacle with cover 200 and base 300 partially joined, according to exemplary embodiments of the present disclosure. The partially-joined arrangement shown in FIG. 5 can occur prior, or subsequent, to the fully-joined arrangement shown in FIG. 4. In other words, the partially-joined arrangement of FIG. 5 can be an intermediate state during the joinder or separation of cover 200 and base 300. As shown in FIG. 5, locking tab 320a is not engaged with locking receptacle 235a in the partially-joined arrangement; moreover, locking tab 320a is not shown because it is hidden behind side 235a of cover 200. Although not shown, other locking tabs and receptacles can be in a similar relative orientation.

In the exemplary partially-joined arrangement shown in FIG. 5, separating tab 220 does not separate protrusions 342a-b, such that terminals 340a-b are in direct electrical contact with each other (i.e., shorted). If the electrical receptacle comprising cover 200 and base 300 were energized, the direct electrical contact of terminals 340a-b can result in an overload condition.

In other exemplary embodiments (not shown), the electrical receptacle can be configured such that, in the partially-joined arrangement shown in FIG. 5, at least a portion of separating tab 220 remains between protrusions 342a-b, such that terminals 340a-b remain electrically isolated from each other. For example, separating tab 220 can be of sufficient length to separate protrusions 342a-b immediately before (after) locking tabs 320a-d are engaged with locking receptacles 235a-d during joinder (separation) of cover 200 and base 300.

FIG. 6 is an isometric, cut-away top view showing the electrical receptacle with cover and base separated, according to exemplary embodiments of the present disclosure. The separated arrangement shown in FIG. 6 can occur prior, or subsequent, to the partially-joined arrangement shown in FIG. 5. In other words, the separated arrangement of FIG. 6 can be an initial (final) state during joinder (separation) of cover 200 and base 300. As shown in FIG. 6, locking tab 320a is not engaged with locking receptacle 235a, and separating tab 220 is not disposed between protrusions 342a-b, such that terminals 340a-b are in direct electrical contact with each other (i.e., shorted). Similar to the arrangement shown in FIG. 5, if the electrical receptacle shown in FIG. 6 were energized, the direct electrical contact of terminals 340a-b can result in an overload condition.

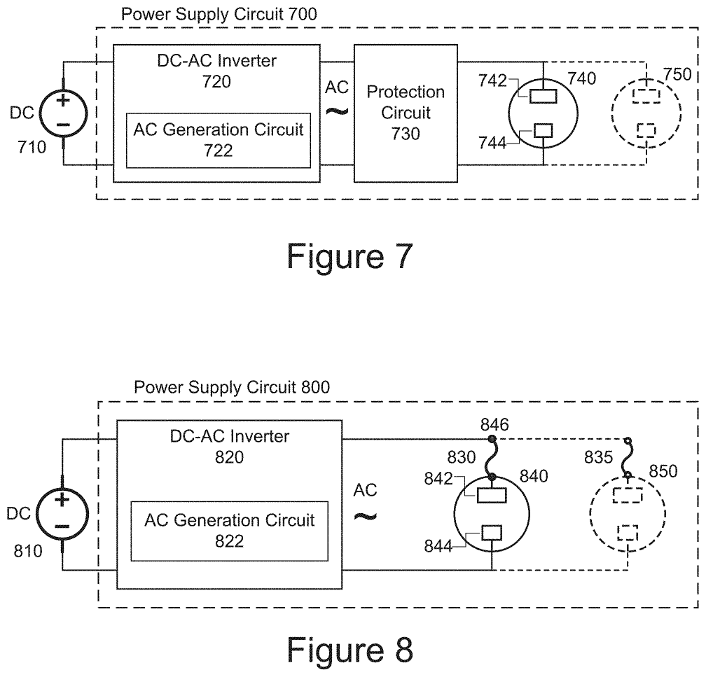

FIG. 7 is a block diagram of a power supply circuit 700, according to various exemplary embodiments of the present disclosure. Power supply circuit 700 can receive DC current and voltage from a DC energy source, e.g., DC source 710 as shown in FIG. 7. In some exemplary embodiments, DC source 710 can be a battery. In other exemplary embodiments, DC source 710 can be a rectified and filtered version of an AC source, e.g., an output of a vehicle alternator.

Power supply circuit 700 can include a DC-AC inverter 720 that receives current and voltage from DC source 710 and outputs AC current and voltage, e.g., via AC generation circuit 722. Power supply circuit 700 can also include a protection circuit 730, which is shown in FIG. 7 as positioned between the output of DC-AC inverter 720 and one or more electrical receptacles, shown as a first receptacle 740 and a second, optional receptacle 750. Even so, this configuration of protection circuit 730 is merely exemplary for the purposes of illustration and, as explained below in relation to FIGS. 8-9, various other embodiments of protection circuit 730 are possible.

In various exemplary embodiments, each of receptacles 740 and 750 can comprise any of the electrical receptacles shown in, and described above in relation to, FIGS. 1-6. As shown in FIG. 7, receptacle 740 comprises a pair of electrically conductive terminals (e.g., line and neutral) labelled 742 and 744. As shown but not labelled, receptacle 750 comprises a similar pair of electrically conductive terminals. Each terminal of the pair can take on various shapes for compatibility with one or more plug terminal arrangements, such as discussed above.

In general, protection circuit 730 can enable DC-AC inverter 720 to energize receptacle(s) 740 and/or 750 when power supply circuit 700 is in a normal operating condition and prevent DC-AC inverter 720 from energizing the receptacle(s) when power supply circuit 700 is in an overload condition. For example, protection circuit 730 can be configured to protect power supply circuit 700 from various overload conditions that can occur with respect to receptacles 740 and/or 750. Such overload condition can result from contact between two opposite terminals (e.g., terminals 742, 744) of a pair comprising a receptacle (e.g., 740). As explained above, this contact can further result from the cover portion of a receptacle (e.g., 740) being separated from or partially joined with the base portion of the receptacle, depending on the particular embodiment. In some exemplary embodiments, protection circuit 730 can also prevent DC-AC inverter 720 from energizing the receptacle(s) when power supply circuit 700 is in a no-load condition.

FIG. 8 is a block diagram of certain embodiments of the power supply circuit shown in FIG. 7. Similar to FIG. 7, power supply circuit 800 comprises DC-AC inverter 820, which is connected to a DC input 810 and provides an AC output, e.g., via AC generation circuit 822. Power supply circuit 800 also includes one or more electrical receptacles, shown as a first receptacle 840 and a second (optional) receptacle 850. Receptacles 840 and 850 can have characteristics similar to receptacles 740 and 750, described above in relation to FIG. 7.

The exemplary embodiments shown in FIG. 8 also include a protection circuit in the form of fuse 830 associated with receptacle 840 and, optionally, fuse 835 associated with receptacle 850. More generally, each receptacle comprising power supply circuit 800 can have a unique fuse associated with that receptacle. Each of those fuses can protect the power supply circuit 800 from an overload condition that occurs in the associated receptacle, e.g., due to contact between two terminals (e.g., 842, 844) of a receptacle (e.g., 840). As explained above, this contact between opposing terminals can result from the cover portion of the receptacle being separated from or partially joined with the base portion, depending on the particular embodiment.

Fuses 830 and 835 can be configured to permanently open (e.g., “blow”) when the amount of current carried by the particular fuse exceeds an approximate, predetermined amount. As shown in FIG. 8, each fuse is in series with the associated receptacle. As such, once a fuse blows, the associated receptacle becomes inoperable until the fuse and/or the receptacle is replaced, e.g., during service.

In some exemplary embodiments, each of fuses 830 and 835 can be integral with the associated receptacles 840 and 850, respectively. For example, receptacle 840 can include a source terminal 846 coupled to one output line of DC-AC inverter 820 (e.g., output of AC generation circuit 822), and fuse 830 can be disposed between source terminal 846 and terminal 842. Alternately, source terminal 846 can be coupled to the other output line of DC-AC inverter 820, with fuse 830 disposed between source terminal 846 and terminal 844. In such embodiments, once fuse 830 (835) blows, receptacle 840 (850) can become inoperable until replaced during service.

FIG. 9 is a block diagram of other exemplary embodiments of the power supply circuit shown in FIG. 7. Similar to FIGS. 7 and 8, power supply circuit 900 comprises DC-AC inverter 920, which is connected to a DC source 910 and provides an AC output, e.g., via AC generation circuit 922. Power supply circuit 900 also includes one or more electrical receptacles, shown as a first receptacle 940 and a second (optional) receptacle 950. Receptacles 940 and 950 can have characteristics similar to receptacles 740 and 750, described above.

The exemplary embodiments shown in FIG. 9 also include a protection circuit in the form of load detection circuit 924, processing circuit 926, and, in some embodiments, input switch 928. Load detection circuit 924 can be disposed between the output of AC generation circuit 922 and receptacles 940 and 950. Likewise, input switch 926 can be disposed between DC source 910 and the inputs of AC generation circuit 922. The operation of the protection circuit according to these embodiments will be described below.

Load detection circuit 924 can be configured to measure one or more parameters associated with the DC-AC inverter's AC output to receptacle 940 and (optionally) 950. In some embodiments, the one or more parameters comprise an AC current output and a load resistance associated with one or more of the receptacles. Load detection circuit 924 can provide the measured one or more parameters to processing circuit 926 (as illustrated by the arrow in FIG. 9), which can be configured to compare the measured parameters with corresponding parameter threshold(s) associated with the overload condition.

For example, processing circuit 926 can compare the measured current output against an overload current threshold and, in some cases, compare the measured load resistance against an overload resistance threshold. This comparison can indicate an overload condition in various ways. In some embodiments, an overload condition can be indicated by one of the parameters (e.g., current output) being greater than the corresponding threshold (e.g., overload current threshold). In some embodiments, an overload condition can be indicated by one of the parameters (e.g., load resistance) being less than the corresponding threshold (e.g., overload resistance threshold). In some embodiments, an overload condition can be indicated by a combination of parameters being greater than and/or less than corresponding thresholds.

Processing circuit 926 can be further configured to, if the comparison(s) indicate(s) an overload condition, perform at least one of the following operations: 1) disable AC generation circuit 922; and 2) decouple AC generation circuit 922 from DC source 910. This control by processing circuit 926 is illustrated by arrows in FIG. 9. Processing circuit 926 can disable AC generation circuit 922 by, e.g., inhibiting one or more functions of circuit 922 such that it no longer generates an AC output. For example, in some embodiments, processing circuit 926 can disable a pulse-width modulated (PWM) switching apparatus comprising AC generation circuit 922. Similarly, processing circuit 926 can decouple AC generation circuit 922 from DC source 910 by causing and/or controlling input switch 928 to open.

In some exemplary embodiments, processing circuit 926 can be further configured to generate a diagnostic trouble code (DTC) if the comparison with the first thresholds indicates an overload condition. In some exemplary embodiments, processing circuit 926 can be further configured to prevent DC-AC inverter 920 from energizing receptacles 940 and 950 when the power supply circuit is in a no-load condition. In such exemplary embodiments, processing circuit 926 can be further configured to compare the measured one or more parameters with corresponding second thresholds associated with the no-load condition. This comparison can indicate a no-load condition in various ways.

In some embodiments, a no-load condition can be indicated by one of the parameters (e.g., current output) being less than the corresponding threshold (e.g., no-load current threshold). In some embodiments, a no-load condition can be indicated by one of the parameters (e.g., load resistance) being greater than the corresponding threshold (e.g., no-load resistance threshold). In some embodiments, a no-load condition can be indicated by a combination of parameters being greater than and/or less than corresponding thresholds. Processing circuit 926 can be further configured to, if the comparison(s) indicate(s) a no-load condition, perform at least one of the following operations: 1) disable AC generation circuit 922; and 2) decouple AC generation circuit 922 from DC source 910. Processing circuit 926 can be configured to perform such operations in a similar manner as discussed above with respect to a detected overload condition.

More generally, processing circuit 926 can comprise one or more digital processors that are operably connected to at least one memory, e.g., a program memory and a data memory. Program memory can store executable instructions (e.g., software, code, program, etc.) that, when executed by the processor(s), facilitates, causes, and/or configures processing circuit 926 to perform the operations discussed above and/or any of the exemplary methods and/or procedures described below. In some embodiments, the program memory can also include executable instructions that, when executed by the processor(s), facilitate, cause, and/or configure processing circuit 926 to perform other functions associated with power supply circuit 900. Data memory can comprise an area usable to store variables, tables, and/or other information used in such operations.

Moreover, any program memory and/or data memory comprising processing circuit 926 can include non-volatile memory (e.g., flash memory), volatile memory (e.g., static or dynamic RAM), or a combination thereof. Persons of ordinary skill in the art will recognize that processing circuit 926 can comprise multiple individual processors (including, e.g., multi-core processors), each of which can implement a portion of the functionality described above. In such cases, multiple individual processors can be commonly connected to program memory and/or data memory, or individually connected to multiple individual program memories and/or data memories. More generally, persons of ordinary skill in the art will recognize that processing circuit 926 can be implemented in many different computer arrangements comprising different combinations of hardware and software including, but not limited to, application processors, signal processors, general-purpose processors, multi-core processors, ASICs, and fixed and/or programmable digital circuitry.

FIG. 10 is a flow diagram of an exemplary method and/or procedure performed for protecting a power supply circuit from an overload condition, according to one or more exemplary embodiments of the present disclosure. The exemplary method shown in FIG. 10 can be implemented, for example, in a processing circuit comprising the power supply circuit, such as illustrated in exemplary FIG. 9 above. Although FIG. 10 shows blocks in a particular order, this order is merely exemplary, and the operations can be performed in a different order than shown in FIG. 10, and can be combined and/or divided into blocks having different functionality. Optional operations are illustrated by blocks with dashed outlines.

The exemplary method and/or procedure shown in FIG. 10 can include the operations of block 1010, where the processing circuit can detect an overload condition of the power supply circuit, the overload condition resulting from separation of a cover portion of the electrical receptacle from a base portion of the electrical receptacle. In some exemplary embodiments, the processing circuit can detect the overload condition based on an input from a load detection circuit comprising the power supply circuit, such as illustrated in the exemplary arrangement shown in FIG. 9.

The exemplary method and/or procedure shown in FIG. 10 can include the operations of block 1020, where the processing circuit can, in response to detecting the overload condition, perform at least one of the following operations: decouple the power supply circuit from an energy source; and disable an output of the power supply circuit that is coupled to the electrical receptacle. In some exemplary embodiments, the processing circuit can decouple the power supply circuit from the energy source (e.g., a DC source) by actuating one or more switches, such as illustrated in the exemplary arrangement shown in FIG. 9. In some exemplary embodiments, the processing circuit can disable an output of the power supply circuit by disabling an AC generation circuit, such as illustrated in the exemplary arrangement shown in FIG. 9.

In some embodiments, the exemplary method and/or procedure shown in FIG. 10 can also include the operations of block 1030, where the processing circuit can detect a normal operating condition of the power supply circuit, the normal operating condition resulting from the cover portion and the base portion being at least partially joined. In some exemplary embodiments, the normal operating condition can result from the cover portion and the base portion being fully joined. In some exemplary embodiments, the processing circuit can detect the overload condition based on an input from the load detection circuit.

In some embodiments, the exemplary method and/or procedure shown in FIG. 10 can also include the operations of block 1040, where the processing circuit can, in response to detecting the normal operating condition, perform at least one of the following operations: couple the power supply circuit to the energy source; and enable the output of the power supply circuit. In some exemplary embodiments, the processing circuit can perform these operations in a substantially similar, but complementary, manner as the operations discussed above with respect to block 1020.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. An electrical receptacle, comprising:
a base formed of electrically insulating material and arranged to hold at least one pair of electrically conductive terminals; and
a cover formed of electrically insulating material and configured to be joinable with the base, the cover comprising:
a top portion having a bottom surface; and
at least one separating tab attached to the bottom surface at an angle of approximately 90 degrees;
wherein each separating tab is arranged to separate two terminals comprising one of the pairs of electrically conductive terminals, only when the cover is at least partially joined with the base.

2. The electrical receptacle of claim 1, wherein the base further comprises:
an inner portion arranged to hold the at least one pair of electrically conductive terminals; and
an outer portion comprising four sides, wherein at least two of the sides comprise locking tabs.

3. The electrical receptacle of claim 2, wherein each adjacent pair of sides of the base outer portion are joined at an angle of approximately 90 degrees.

4. The electrical receptacle of claim 2, wherein:
the cover further comprises a side portion attached to the bottom surface of the top portion at an angle of approximately 90 degrees;
the cover side portion comprises four sides;
at least two sides of the cover side portion comprise locking receptacles; and
the locking receptacles are arranged to engage with the locking tabs when the cover and the base are fully joined.

5. The electrical receptacle of claim 4, wherein the locking receptacles are arranged to not engage with the locking tabs when the cover and the base are partially joined or separated.

6. The electrical receptacle of claim 4, wherein each adjacent pair of sides of the cover side portion are joined at an angle of approximately 90 degrees.

7. The electrical receptacle of claim 1, wherein the cover top portion further comprises at least two apertures arranged such that, when the base and the cover are at least partially joined, each aperture is disposed above a corresponding one of the electrically conductive terminals.

8. The electrical receptacle of claim 1, further comprising:
a source terminal coupled to a first terminal of each pair of electrically conductive terminals; and
a fuse disposed between the source terminal and the respective first terminals.

9. The electrical receptacle of claim 1, wherein each separating tab is arranged to separate the two terminals comprising one of the pairs of electrically conductive terminals, only when the cover is fully joined with the base.

10. A power supply circuit comprising:
a DC-AC inverter comprising an AC generation circuit;
an electrical receptacle comprising a base and a cover, wherein:
the base and the cover are formed of electrically insulating material,
the cover is configured to be joinable with the base,
the base is arranged to hold at least one pair of electrically conductive terminals that are electrically coupled to the DC-AC inverter,
the cover comprises a top portion having a bottom surface and at least one separating tab attached to the bottom surface at an angle of approximately 90 degrees, and
each separating tab is arranged to separate two terminals comprising a particular pair of electrically conductive terminals, only when the cover is at least partially joined with the base; and
a protection circuit configured to prevent the DC-AC inverter from energizing the electrical receptacle when the power supply circuit is in an overload condition resulting from contact between two terminals comprising one of the pairs of electrically conductive terminals.

11. The power supply circuit of claim 10, wherein the protection circuit is a fuse.

12. The power supply circuit of claim 11, wherein the fuse is integral with the electrical receptacle.

13. The power supply circuit of claim 12, wherein:
the electrical receptacle further comprises a source terminal coupled to an output of the AC generation circuit; and
the fuse is disposed between the source terminal and a first terminal of each pair of electrically conductive terminals.

14. The power supply circuit of claim 10, wherein the protection circuit is integral with the DC-AC inverter and comprises:
a load detection circuit configured to measure one or more parameters associated with the DC-AC inverter's AC output to the electrical receptacle; and
a processing circuit configured to:
compare the measured one or more parameters with corresponding first thresholds associated with the overload condition; and
if the comparison with the first thresholds indicates an overload condition, perform at least one of the following operations:
decouple the DC-AC inverter from a DC supply input; and
disable the AC generation circuit.

15. The power supply circuit of claim 14, wherein:
the protection circuit further comprises an input switch disposed between the DC supply input and the DC-AC inverter; and
the processing circuit is configured to decouple the DC-AC inverter from the DC supply input by opening the input switch.

16. The power supply circuit of claim 14, wherein the processing circuit is further configured to generate a diagnostic trouble code (DTC) if the comparison with the first thresholds indicates an overload condition.

17. The power supply circuit of claim 10, wherein the protection circuit is further configured to enable the DC-AC inverter to energize the electrical receptacle when the power supply circuit is in a normal operating condition.

18. The power supply circuit of claim 10, wherein the protection circuit is further configured to prevent the DC-AC inverter from energizing the electrical receptacle when the power supply circuit is in a no-load condition.

19. The power supply circuit of claim 18, wherein the processing circuit is further configured to:
compare the measured one or more parameters with corresponding second thresholds associated with the no-load condition; and
if the comparison with the second thresholds indicates a no-load condition, perform at least one of the following operations:
decouple the DC-AC inverter from the DC supply input; and
disable the AC generation circuit.

20. The power supply circuit of claim 10, wherein:
the electrical receptacle base further comprises a side portion attached to a top surface of the bottom portion at an angle of approximately 90 degrees;
the base side portion comprises four sides; and
at least two opposite sides of the base side portion comprise locking tabs.

21. The power supply circuit of claim 20, wherein:
the electrical receptacle cover further comprises a side portion attached to the bottom surface of the top portion at an angle of approximately 90 degrees;
the cover side portion comprises four sides; and
at least two sides of the cover side portion comprise locking receptacles, wherein the locking receptacles are arranged to engage with the locking tabs when the cover and the base are fully joined.

22. The power supply circuit of claim 21, wherein the locking receptacles are arranged to not engage with the locking receptacles when the cover and the base are partially joined or separated.

23. The power supply circuit of claim 10, wherein the cover top portion further comprises at least one pair of apertures through the cover top portion and arranged such that, when the base and the cover are joined, each aperture is disposed above a corresponding one of the electrically conductive terminals.

24. A method for protecting a power supply circuit, comprising an electrical receptacle, against an overload condition, the method comprising
detecting an overload condition of the power supply circuit, the overload condition resulting from separation of a cover portion of the electrical receptacle from a base portion of the electrical receptacle;
in response to detecting the overload condition, performing at least one of the following operations:
decoupling the power supply circuit from an energy source; and
disabling an output of the power supply circuit that is coupled to the electrical receptacle.

25. The method of claim 24, further comprising:
detecting a normal operating condition of the power supply circuit, the normal operating condition resulting from the cover portion and the base portion being at least partially joined; and
in response, performing at least one of the following operations:
coupling the power supply circuit to the energy source; and
enabling the output of the power supply circuit.
